(19) United States
(12) Patent Application Publication
(10) Pub. No.: US 2010/0056398 A1
(43) Pub. Date: Mar. 4, 2010

(54) THICKENER COMPOSITION

(75) Inventors: Ulrich Steinbrenner, Neustadt (DE); Günter Oetter, Frankenthal (DE); Uwe Ossmer, Houston, TX (US); Marcus Guzmann, Muhlhausen (DE)

Correspondence Address: CONNOLLY BOVE LODGE & HUTZ, LLP, P O BOX 2207, WILMINGTON, DE, 19899, US

(73) Assignee: BASF SE, Ludwigshafen (DE)

(21) Appl. No.: 12/516,857

(22) PCT Filed: Nov. 29, 2007
(86) PCT No.: PCT/EP2007/063012

§ 371 Date: May 29, 2009

Related U.S. Application Data
(60) Provisional application No. 60/916,618, filed on May 8, 2007.

(30) Foreign Application Priority Data
Nov. 30, 2006 (EP) 06125152.6
May 8, 2007 (EP) 07107756.4

(51) Int. Cl. C09K 8/24; C08K 5/53; C08K 5/41; C08K 5/09; C11D 3/38; C09K 8/60

(52) U.S. Cl. 507/117; 524/131; 524/130; 524/156; 524/140; 524/157; 524/284; 510/467; 507/219

(57) ABSTRACT

Thickener systems which are suitable for preparing thickener compositions, and which systems consists of (A) at least one anionic surfactant A and (B) at least one polymer B comprising at least one hydrophobic group and preferably at least one hydrophilic group, wherein the concentration of the polymer B in a thickener composition is below the overlap concentration c* of the polymer, along with processes for preparing such compositions and uses thereof.

The present invention relates to thickener compositions which are useful for use in aqueous compositions, especially in the field of the development and extraction of mineral oil and natural gas deposits.

The viscosity of aqueous systems plays a crucial role for a multitude of applications. Thickener compositions in water-based systems, for example borehole treatment fluids, detergent compositions, washing compositions, formulations for the treatment of leather and textiles, hydraulic fluids, etc. are frequently used in order to provide the rheological properties required for their specific applications.

WO 2005/040554 describes the use of organic compounds, especially alcohols and amines, in order to increase the viscosity of gels of viscoelastic surfactants and to lower the amount of salt used in order to ensure a particular viscosity.

WO 2005/071038 describes compositions of viscoelastic surfactants, especially of betaines and quaternized amines, which comprise small amounts of an amphiphilic triblock oligomer, which brings about a shortening of the relaxation time after shear and additionally increases the viscosity of the composition.

US 2005/0107503 describes aqueous compositions which comprise a viscoelastic surfactant and a hydrophobically modified polymer in a concentration above its overlap concentration c* and below its entanglement concentration cₑ.

EP 061251.6, unpublished at the priority date of this document, describes aqueous thickener compositions with pH-dependent viscosity which are especially suitable for the development and extraction of mineral oil and natural gas deposits.

It was an object of the present application to provide thickener compositions which are notable for a thickening action suitable for their end use and are additionally notable for a method of provision which bypasses the problems which occur in the provision of the known thickener compositions, especially those problems connected to the viscosity of the thickeners and surfactants used. The thickener compositions should preferably additionally reform the gel within a short time after shear. Moreover, it is advantageous when the thickener systems or thickener compositions are and remain homogeneous over a wide temperature range, i.e. that there is no separation of the components present. The homogenization is manifested, for example, in that the thickener systems or thickener composition are present in the form of a clear fluid. Depending on the intended use, a further advantage can arise from the fact that the thickener composition is viscous and not viscoelastic at low shear rates.

It has been found that, surprisingly, the viscosity of thickener compositions and the temperature at which the viscosity of such thickener compositions decreases are significantly increased merely by addition of amounts of polymers below their overlap concentration c*.

The present invention therefore provides a thickener system which is suitable for preparing a thickener composition and consists of

(A) at least one anionic surfactant A and

(B) at least one polymer B which has at least one hydrophobic group,

the concentration of the polymer B in the thickener composition being below the overlap concentration c* of the polymer.

The overlap concentration c* of the polymer B is determined by logarithmic plotting of the viscosity of an aqueous solution of the polymer (without addition of the surfactant A) at a given shear rate against the log of the concentration. The overlap concentration c* corresponds to the concentration of the polymer B which corresponds to the point of intersection of the lines of best fit of the two linear slopes of the resulting function. In the overlapping networks of the inventive thickener compositions, the concentration of the polymers B is below their overlap concentration c*.

The inventive thickener systems consisting of component A and B are used to adjust the rheological properties of inventive thickener compositions. As well as the inventive thickener system, the thickener compositions comprise water, inorganic salts and if appropriate further components specified below.

The use amount of the components other than water and salt, including components A and B, in the thickener compositions is typically within a range of from 0.1 to 10% by weight, preferably from 0.5 to 6% by weight, more preferably from 2 to 4% by weight, based on the total weight of the thickener compositions. In this connection, the expression “salt” does not comprise the salts of components A and B and if appropriate further organic components which are present in the form of their salts.

The term “viscosity” relates, in the context of the present invention, generally to the dynamic viscosity. Methods for determining the viscosity are explained hereinafter.

The term “rheological properties” is used in a broad sense in the context of the present invention and means both viscosity and elasticity, but preferably viscosity.

The inventive thickener systems preferably comprise anionic surfactants A which are present in the preparable thickener composition in a concentration at which, without addition of the polymer B, at a shear rate of 100 rad/s, a viscosity of 20 mPa·s is not exceeded. More preferably, the viscosity of the anionic surfactants A under these conditions is less than 10 mPa·s.

The inventive thickener systems preferably comprise polymers B which are present in the preparable thickener composition in a concentration at which, without addition of the anionic surfactant A, at a shear rate of 100 rad/s, a viscosity of 5 mPa·s is not exceeded.

The present invention further relates to the use of an inventive thickener system for preparing a thickener composition.

The present invention further relates to a process for preparing a thickener composition, comprising
(a) the provision of at least one surfactant A and at least one polymer B,
(b) the preparation of a solution of the anionic surfactant A provided in an aqueous medium,
(c) the preparation of a solution of the polymer B provided in an aqueous medium and
(d) the mixing of the solutions of the surfactant A and of the polymer B prepared,
   the concentration of the polymer B in the thickener composition prepared being below the overlap concentration c* of the polymer.

The concentration of the polymer B in the thickener composition prepared is preferably at least 0.1c*. More preferably, the concentration of the polymer B in the thickener composition prepared is within a range from 0.3 to 0.7 c*

In a preferred embodiment of the process according to the invention, the solution of the anionic surfactant A prepared in step b), at a shear rate of 100 rad/s, does not exceed a viscosity of 20 mPa·s.

In a further preferred embodiment of the process according to the invention, the solution of the polymer B prepared in step c), at a shear rate of 100 rad/s, does not exceed a viscosity of 5 mPa·s.

In a particularly preferred embodiment of the process according to the invention, the solution of the anionic surfactant A prepared in step b), at a shear rate of 100 rad/s, does not exceed a viscosity of 20 mPa·s and the solution of the polymer B prepared in step c) does not exceed a viscosity of 5 mPa·s.

The above-described process for preparing an inventive thickener composition is notable especially in that, even at comparatively high concentrations, neither the solution of the surfactant A nor the solution of the polymer B has a high viscosity. This ensures that there is no poor solubility caused by premature gel formation, as is the case in the formulation of conventionally used thickeners, in the form of concentrates or powders.

More preferably, the anionic surfactants A in the inventive thickener systems and compositions are selected from compounds of the general formulae (I.a) to (I.f) and salts thereof

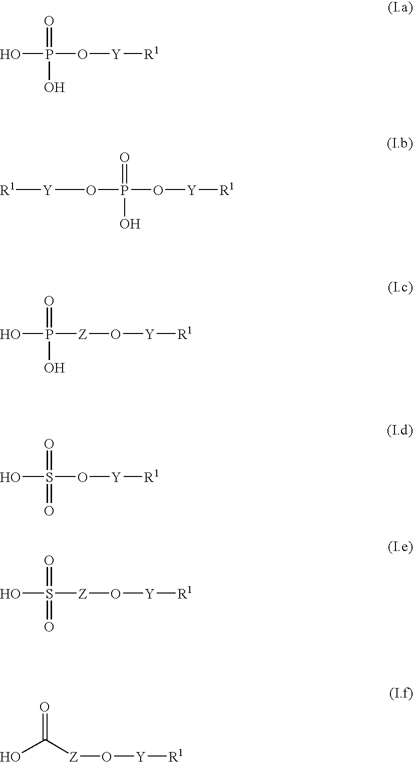

in which
R¹ is selected from linear or branched C₁₆-C₂₂-alkyl, C₁₆-C₂₂-alkenyl, C₁₆-C₂₂-alkynyl, (C₁₅-C₂₁-alkyl)carbonyl, (C₁₅-C₂₁-alkenyl)carbonyl and (C₁₅-C₂₁-alkynyl)carbonyl,
Y is a group consisting of from 1 to 20 alkyleneoxy units and
Z is C₁-C₄-alkylene.

When the salts of the compounds (I.a) to (I.f) are used, they comprise, as well as the anion of the particular compounds, a corresponding positively charged counterion, for example Na⁺or K⁺.

In the context of the present invention, the expression “alkyl” comprises straight-chain and branched alkyl groups. Suitable short-chain alkyl groups are, for example, straight-chain or branched C₁-C₇-alkyl, preferably C₁-C₆-alkyl and more preferably C₁-C₄-alkyl groups. These include in particular methyl, ethyl, propyl, isopropyl, n-butyl, 2-butyl sec-butyl, tert-butyl, etc.

In the context of the present invention, the expression “C₁₁-C₂₂-alkyl” comprises straight-chain and branched alkyl groups. They are preferably straight-chain and branched C₁₅-C₂₀-alkyl radicals, more preferably straight-chain and branched C₁₆-C₁₈-alkyl radicals and most preferably straight-chain C₁₆-C₁₈-alkyl radicals. They are especially predominantly linear alkyl radicals, as also occur in natural or synthetic fatty acids and fatty alcohols, and also oxo alcohols. They include, for example, n-undecyl, n-dodecyl, n-tridecyl, myristyl, pentadecyl, palmityl (=cetyl), heptadecyl, octadecyl, nonadecyl, arachinyl, behenyl, etc.

In the context of the present invention, C₈-C₃₂-alkenyl, especially C₁₁-C₂₂-alkenyl, represents straight-chain and branched alkenyl groups which may be mono-, di- or polyunsaturated. They are preferably straight-chain and branched C₁₅-C₂₀-alkenyl, more preferably straight-chain and branched C₁₆-C₁₈-alkenyl and most preferably straight-chain C₁₆-C₁₈-alkenyl. They are especially predominantly linear alkenyl radicals, as also occur in natural or synthetic fatty acids and fatty alcohols, and also oxo alcohols. They include in particular octenyl, nonenyl, decenyl, undecenyl, dodecenyl, tridecenyl, tetradecenyl, pentadecenyl, hexadecenyl, heptadecenyl, octadecenyl, nonadecenyl, linolylyl, linolenylyl, eleostearyl, etc., and especially oleyl (9-octadecenyl).

In the context of the present invention, C₁₁-C₂₂-alkynyl represents straight-chain and branched alkynyl groups which may be mono-, di- or polyunsaturated. They are preferably C₁₅-C₂₀-alkynyl. They are especially predominantly linear alkynyl radicals.

In the context of the present invention, the term “C₁₁-C₂₁-alkylcarbonyl” comprises straight-chain and branched alkyl groups as defined above, which are bonded via a carbonyl group (—C(═O)—). The same applies to the terms “C₁₁-C₂₁-alkenylcarbonyl” and “C₁-C₂₁-alkynylcarbonyl”.

The R¹ radicals of the compounds of the general formulae (I.a) to (I.f) have, on average, preferably at most one, more preferably at most 0.5 and especially at most 0.2 branch. In particular, the R¹ radicals are each independently selected from palmityl, stearyl, oleyl, linoleyl, arachidyl, gadoleyl, behenyl, erucyl, isostearyl, 2-hexyldecyl, 2-heptyldecyl, 2-heptylundecyl and 2-octyldodecyl.

The Y groups in the compounds of the general formulae (I.a) to (I.f) are preferably selected from groups of the general formula (II),

—[(O—(CH₂)₂)ₓ₁(O—CH(CH₃)CH₂)ₓ₂]— (II)
in which the sequence of the alkyleneoxy units is as desired and
x¹ and x² are each independently an integer from 0 to 20, where the sum of x¹ and x² is from 1 to 20.

The ratio of x¹ to x² averaged over the surfactants of the general formulae (I.a) to (I.f) present is preferably at least 2:1. In a specific embodiment of the inventive composition, the poly(alkyleneoxy) groups of the general formula (II) consist exclusively of ethyleneoxy units. x² is thus especially 0.

In the compounds of the formulae (I.a) to (I.f), the ratio of the anionogenic groups to the alkyleneoxy units of the R¹ groups is preferably within a range of from 1:2 to 1:10. In this connection, anionogenic groups refer to those groups which have an acidic proton and form an anionic group under basic conditions. When, instead of the compounds of the formulae (I.a) to (I.f), their salts are used, the aforementioned ratio relates correspondingly to the anionic groups.

The surfactants A are preferably selected from compounds of the general formulae (I.a) or (I.b). The surfactants A are more preferably selected from compounds of the formula (I.a).

Surfactants of the general formulae (I.a) and (I.b) used in accordance with the invention can, for example, be provided by reacting phosphoric acid or a suitable phosphoric acid derivative, for example P₂O₅, P₄O₁₀, polyphosphoric acid (H₃PO4^{x}(HPO₃)ₙ where n≧1or metaphosphoric acid ((HPO₃)ₙ where n>3), with a suitable alkoxylated alcohol of the formula R¹—[(O—(CH₂)₂)ₓ₁(O—CH(CH₃)CH₂)ₓ₂]—OH or mixtures of these alkoxylated alcohols, as are provided especially by reacting natural or synthetic mixtures of fatty alcohols and oxo alcohols with ethylene oxide and/or propylene oxide. As well as inorganic phosphoric acids, this typically affords mixtures of phosphoric monoesters and phosphoric diesters of the general formula (I.a) and (I.b).

The inventive thickener systems and compositions comprise preferably, as anionic surfactants A, at least one phosphoric monoester of the general formula (I.a). Preferably at least 50%, more preferably at least 80% and especially at least 90% of the surfactants A present are selected from compounds of the general formula (I.a).

The inventive thickener systems comprise advantageously an amount in the range from 50 to 99.9% by weight, preferably from 70 to 99.5% by weight and more preferably from 80 to 99% by weight of anionic surfactant A.

The inventive thickener compositions comprise advantageously an amount in the range from 0.5 to 9.9% by weight, preferably from 0.7 to 5.0% by weight and more preferably from 1 to 3% by weight of surfactants A based on the total weight of components in the inventive composition other than water and salt.

The inventive thickener systems comprise advantageously an amount in the range of from 0.1 to 50% by weight, preferably from 0.5 to 30% by weight and more preferably from 1 to 20% by weight of polymer B.

The inventive thickener compositions comprise advantageously an amount in the range from 0.001 to 5% by weight, preferably from 0.005 to 3% by weight and more preferably from 0.01 to 2% by weight of polymer B based on the total weight of the components in the inventive composition other than water and salt.

The concentration of the polymer B in the inventive thickener compositions is preferably at least 0.1 c*. More preferably, the concentration of the polymer B is within a range of from 0.2 to 0.7 c*.

The polymer B in the inventive thickener systems and compositions is preferably selected from compounds comprising at least one hydrophobic group and at least one hydrophilic group.

The polymer B in the inventive thickener systems and compositions is preferably selected from compounds comprising at least two hydrophobic radicals R², which are bonded to one another via a bridging hydrophilic group (α).

The polymers B are preferably water-soluble. These polymers B comprise hydrophilic groups (α), to which the hydrophobic R² groups are bonded. For this reason, the polymers B are simultaneously hydrophobic and hydrophilic. The hydrophobic R² groups preferably have a structure which corresponds to the hydrophobic R¹ groups of the surfactants A.

The rheological properties of the inventive thickener compositions are determined by interactions of the polymers (B), specifically of their hydrophobic R² groups, with micelles of the surfactants A. These interactions are physical hydrophobic-hydrophobic interactions. This forms overlapping networks.

Surfactants form micelles in water even at very low concentrations. The concentration at which the first micelles are formed is referred to as the critical micelle concentration (cmc). This is typically determined by the surface tension, solubilization, conductivity (in ionic surfactants) or NMR. The anionic surfactants A used with preference in accordance with the invention are notable for a relatively high critical micelle concentration. The critical micelle concentration of such anionic surfactants A is preferably within a range from 1 to 50 mg/l and more preferably within a range from 15 to 30 mg/I. The ranges specified relate to the concentrations determined at 25° C. for a salt concentration and a pH which correspond to the use conditions. In order to form overlapping networks, the concentration of the surfactant A in the thickener compositions is preferably above its critical micelle concentration.

The hydrophobic R² groups of the polymers B comprise, on average, preferably at least 14 and especially at least 16 carbon atoms. The upper limit of the carbon atom number is generally uncritical and is, for example, up to 100, preferably up to 50 and especially up to 35. More preferably, less than 10% of the hydrophobic R² groups present in the polymers B comprise less than 15 and more than 23 carbon atoms.

Preferably, on average, less than 20% and especially less than 5% of the R² groups present have a carbon-carbon double bond.

The hydrophobic R² groups are preferably selected from linear and branched C₁₂-C₂₂-alkyl, C₁₂-C₂₂-alkenyl or 2-hydroxy(C₁₂-C₂₂-alk-1-yl).

The R² radicals of the polymers B present in the inventive thickener systems have, on average, preferably at most one, more preferably at most 0.5 and especially at most 0.2 branch. In particular, the R² radicals are each independently selected from palmityl, stearyl, oleyl, linoleyl, arachidyl, gadoleyl, behenyl, erucyl, isostearyl, 2-hexyldecyl, 2-heptyldecyl, 2-heptylundecyl, 2-octyldodecyl and 2-hydroxypalmityl, 2-hydroxystearyl, 2-hydroxyoleyl, 2-hydroxylinoleyl, 2-hydroxyarachidyl, 2-hydroxygadoleyl, 2-hydroxybehenyl, 2-hydroxyerucyl and 2-hydroxyisostearyl.

Preferably at least 70% of the R² groups present in the polymers B are unbranched.

In a specific embodiment, hydrophilic groups (α) which comprise at least two hydrophilic units (β) are used. The hydrophilic units (β) may have identical or different definitions. Identical hydrophilic units (β) are always bonded to one another via a bridging group (γ). Different hydrophilic units (β) may be bonded directly to one another or via a bridging group (γ).

In a preferred embodiment of the present invention, the bridging hydrophilic group (α) comprises, as hydrophilic units (β), polyether units and/or polyvinyl alcohol units. More preferably, the bridging hydrophilic group (α) consists of polyether units at least to an extent of 90%.

In a specific embodiment of the present invention, the hydrophilic units (β) of the polymers present in the inventive thickener systems are at least partly selected from polyether units of the general formula (III)

—[(O—(CH₂)₂)_{y1}(O—CH(CH₃)CH₂)_{y2}]— (III)
in which the sequence of the alkyleneoxy units is as desired and y¹ and y² are each independently an integer from 0 to 300, where the sum of y¹ and y² is from 10 to 300.

The sum of y¹ and y² denotes the number of alkyleneoxy units of this polyether chain and has, averaged over all polyether units of the formula (III) present, preferably a value in the range from 20 to 200, more preferably from 30 to 150.

The ratio of y¹ to y² expresses the ratio of ethyleneoxy to propyleneoxy units. Averaged over the polyether chain of the general formula (III) present, the ratio of y¹ to y² is preferably at least 2:1, more preferably at least 5:1.

Various hydrophilic polyether units are preferably bonded to one another without bridging groups (γ). These include, for example, EO/PO block copolymer units.

In a specific embodiment of the present invention, the polyether chain of the formula (III) consists exclusively of ethyleneoxy units. In this embodiment, y² is 0.

In a further specific embodiment of the present invention, the hydrophilic groups (α) are composed of hydrophilic units (α) which are bonded to one another via bridging groups (γ), the bridging groups (γ) being structurally different from the repeat units of which the hydrophilic units (β) are composed.

The bridging groups (γ) between the hydrophilic units (β) of the polymer B present in the inventive composition are preferably selected from m-valent, preferably 2- to 4-valent, groups with from 1 to 10 bridging atoms between the flanking bonds, where the m-valent groups has structures which are selected from —OC(═O)—, —C(═O)OC(═O)—, —OC(═O)O—, —OC(═O)NH—, —NC(═O)NH—, alkylene, alkenylene, arylene, heterocyclylene, cycloalkylene, where alkylene and alkenylene may be interrupted once or more than once by oxygen, sulfur, —NH— and —N(C₁-C₁₀-alkyl)-, arylene, heterocyclylene and cycloalkylene may be mono- or polysubstituted by C₁-C₄-alkyl, and m is an integer in the range from 2 to 4. The bridging groups (γ) preferably have —OC(═O)NH— as terminal structural units.

In this context, the term “m-valent group” means that the bridging group (γ) is capable of forming m chemical bonds, where m is an integer and is preferably 2, 3 or 4.

When alkylene or alkenylene is interrupted by one or more, for example 1, 2, 3, 4, 5, 6, 7 or 8 nonadjacent groups which are each independently selected from oxygen, sulfur, —NH— and N(C₁-C₁₀-alkyl)-, the termini of the alkylene or alkenylene group is formed by carbon atoms. The examples thereof are —(CH₂)₃N(CH₃)CH₂—, —(CH₂)₃N(C₂H₅)(CH₂)—, —(CH₂)₃—OCH₂—, —(CH₂)₃—O—CH(CH₃)CH₂—, —(CH₂)₂O(CH₂)₂—OCH₂—, —CH₂—(CH₂)₂—CH₂—N(CH₃)(CH₂)₃—, —(CH₂)₂—N[CH(CH₃)₂]CH₂—, —(CH₂)₂—N(C₂H₅)CH₂—, —(CH₂)₂N(CH₃)CH₂—, —(CH₂)₂OCH₂—, —(CH₂)₂OCH₂CH₂—, —(CH₂)₃—SCH₂—, —(CH₂)₃—S—CH(CH₃)CH₂—, —(CH₂)₂S(CH₂)₂—SCH₂—, —(CH₂)₂SCH₂— and —(CH₂)₂SCH₂CH₂—.

When the m-valent group (γ) has a valency greater than 2, this enables branching of the polymer B. In this case, the polymer (B) may also comprise more than two hydrophobic R² groups.

The polymer B preferably comprises from two to six, more preferably from two to four hydrophobic R² groups.

The preferred range for the molecular weight of the polymer B present arises through multiplication of the number of hydrophobic R² groups present with a value of from 1500 to 8000 g/mol.

The polymers B present in the inventive thickener systems preferably have, on average, a molecular weight in the range from 3000 to 50 000 g/mol, more preferably in the range from 5000 to 30 000 g/mol.

Polymers B used in accordance with the invention can, for example, be provided by reacting polyisocyanates, polyols, polyamines, polycarboxylic acids with a suitable alkoxylated alcohol, for example an alkoxylated alcohol of the formula R²—[(O—(CH₂)₂)_{y1}(O—CH(CH₃)CH₂)_{y2}]—OH or mixtures of these alkoxylated alcohols. These alcohols are provided especially by reacting natural or synthetic mixtures of fatty alcohols and oxo alcohols with ethylene oxide and/or propylene oxide. This typically affords mixtures of alcohols with a different number of alkyleneoxy units, which can be used as such. The polymers B used in accordance with the invention can likewise be provided by reacting compounds which comprise at least two different functional groups with the aforementioned alcohols.

The polymers B are preferably provided starting from polyisocyanates or polyols.

Suitable polyisocyanates, especially diisocyanates and triisocyanates, for providing polymers B are the aliphatic, cycloaliphatic, araliphatic and aromatic di- or polyisocyanates mentioned below by way of example. These preferably include 4,4′-diphenylmethane diisocyanate, the mixtures of monomeric diphenylmethane diisocyanates and oligomeric diphenylmethane diisocyanates (polymer-MDI), tetramethylene diisocyanate, tetramethylene diisocyanate trimers, hexamethylene diisocyanate, hexamethylene diisocyanate trimers, isophorone diisocyanate trimer, 4,4′-methylenebis(cyclohexyl) diisocyanate, xylylene diisocyanate, tetramethylxylylene diisocyanate, dodecyl diisocyanate, lysine alkyl ester diisocyanate where alkyl is C₁-C₁₀-alkyl, 1,4-diisocyanatocyclohexane or 4-isocyanatomethyl-1,8-octamethylene diisocyanate, and more preferably hexamethylene diisocyanate and 4,4′-diphenylmethane diisocyanate.

Suitable diols for providing the polymers B are straight-chain and branched, aliphatic and cycloaliphatic alcohols having generally from about 1 to 30, preferably from about 2 to 20 carbon atoms. These include 1,2-ethanediol, 1,2-propanediol, 1,3-propanediol, 1,2-butanediol, 1,3-butanediol, 1,4-butanediol, 2,3-butanediol, 1,2-pentanediol, 1,3-pentanediol, 1,4-pentanediol, 1,5-pentanediol, 2,3-pentanediol, 2,4-pentanediol, 1,2-hexanediol, 1,3-hexanediol, 1,4-hexanediol, 1,5-hexanediol, 1,6-hexanediol, 2,5-hexanediol, 1,2-heptanediol, 1,7-heptanediol, 1,2-octanediol, 1,8-octanediol, 1,2-nonanediol, 1,9-nonanediol, 1,2-decanediol, 1,10-decanediol, 1,12-dodecanediol, 2-methyl-1,3-propanediol, 2-methyl-2-butyl-1,3-propanediol, 2,2-dimethyl-1,3-propanediol, 2,2-dimethyl-1,4-butanediol, pinacol, 2-ethyl-2-butyl-1,3-propanediol, diethylene glycol, triethylene glycol, dipropylene glycol, tripropylene glycol, polyalkylene glycols, cyclopentanediols, cyclohexanediols, etc.

Suitable triols for providing the polymers B are, for example, glycerol, butane-1,2,4-triol, n-pentane-1,2,5-triol, n-pentane-1,3,5-triol, n-hexane-1,2,6-triol, n-hexane-1,2,5-triol, trimethylolpropane, trimethylolbutane. Suitable triols are also the esters of hydroxycarboxylic acids with trihydric alcohols. They are preferably triglycerides of hydroxycarboxylic acids, for example lactic acid, hydroxystearic acid and ricinoleic acid. Also suitable are naturally occurring mixtures which comprise hydroxycarboxylic acid triglycerides, especially castor oil. Preferred triols are glycerol and trimethylolpropane.

Suitable higher polyhydric polyols for providing polymers B are, for example, sugar alcohols and derivatives thereof, such as erythritol, pentaerythritol, dipentaerythritol, treitol, inositol and sorbitol. Also suitable are reaction products of the polyols with alkylene oxides, such as ethylene oxide and/or propylene oxide. It is also possible to use higher molecular weight polyols with a number-average molecular weight in the range from about 400 to 6000 g/mol, preferably from 500 to 4000 g/mol. These include, for example, polyesterols based on aliphatic, cycloaliphatic and/or aromatic di-, tri- and/or polycarboxylic acids with di-, tri- and/or polyols, and also the polyesterols based on lactone. These further include polyetherols which are obtainable, for example, by polymerizing cyclic ethers or by reacting alkylene oxides with a starter molecule. These further also include customary polycarbonates with terminal hydroxyl groups which are known to those skilled in the art and are obtainable by reacting the above-described diols or else bisphenols, such as bisphenol A, with phosgene or carbonic esters. Also suitable are α,ω-polyamidols, α,ω-polymethyl(meth)acrylate diols and/or α,ω-polybutyl(meth)acrylate diols, for example MD-1000 and BD-1000 from Goldschmidt.

Suitable dicarboxylic acids for providing polymers B are, for example, oxalic acid, malonic acid, succinic acid, glutaric acid, adipic acid, pimelic acid, suberic acid, azelaic acid, sebacic acid, undecane-α,ω-dicarboxylic acid, dodecane-α,ω-dicarboxylic acid, cis- and trans-cyclohexane-1,2-dicarboxylic acid, cis- and trans-cyclohexane-1,3-dicarboxylic acid, cis- and trans-cyclohexane-1,4-dicarboxylic acid, cis- and trans-cyclopentane-1,2-dicarboxylic acid, cis- and trans-cyclopentane-1,3-dicarboxylic acid, phthalic acid, isophthalic acid, terephthalic acid and mixtures thereof.

The abovementioned dicarboxylic acids may also be substituted. Suitable substituted dicarboxylic acids may have one or more radicals which are preferably selected from alkyl, cycloalkyl and aryl, as defined at the outset. Suitable substituted dicarboxylic acids are, for example, 2-methylmalonic acid, 2-ethylmalonic acid, 2-phenylmalonic acid, 2-methylsuccinic acid, 2-ethylsuccinic acid, 2-phenylsuccinic acid, itaconic acid, 3,3-dimethylglutaric acid, etc.

Dicarboxylic acids can be used either as such or in the form of derivatives. Suitable derivatives are anhydrides and their oligomers and polymers, mono- and diesters, preferably mono- and dialkyl esters, and acid halides, preferably chlorides. Suitable esters are mono- or dimethyl esters, mono- or diethyl esters, and also mono- and diesters of higher alcohols, for example n-propanol, isopropanol, n-butanol, isobutanol, tert-butanol, n-pentanol, n-hexanol, etc, and also mono- and divinyl esters and mixed esters, preferably methyl ethyl esters.

Preferred polycarboxylic acids for providing the polymers B are succinic acid, glutaric acid, adipic acid, phthalic acid, isophthalic acid, terephthalic acid or their mono- or dimethyl esters. Particular preference is given to adipic acid.

Suitable polyamines are, for example, ethylenediamine, propylenediamine, diethylenetriamine, triethylenetetramine, tetraethylenepentamine, polyethyleneimine, 1,3-propanediamine, N,N-bis(aminopropyl)amine, N,N,N-tris(aminoethyl)amine, N,N,N′,N′-tetrakis(aminoethyl)ethylenediamine, N,N,N′,N−,N″-pentakis(aminoethyl)diethylenetriamine, neopentanediamine, hexamethylenediamine, octamethylenediamine or isophoronediamine.

Further compounds suitable for providing the polymers (B) are compounds which comprise at least two different functional groups, for example ethanolamine, N-methylethanolamine, propanolamine, hydroxyacetic acid, lactic acid, glutamic acid, aspartic acid.

In a particularly preferred embodiment, the polymer (B) is provided proceeding from (a) C₁₄-C₂₂ fatty alcohol ethoxylates and mixtures thereof, (b) polyethylene glycol, EO-PO copolymers, trimethylolpropane ethoxylates/trimethylolpropane propoxylates, glyceryl ethoxylates/propoxylates and mixtures thereof, and (c) hexamethylene diisocyanates.

In a further particularly preferred embodiment, the polymer B is provided proceeding from (a) polyethylene glycol, EO-PO copolymers, trimethylolpropane ethoxylates/trimethylolpropane propoxylates, glyceryl ethoxylates/propoxylates and mixtures thereof, and (b) 1,2-epoxy-C₁₄-C₂₂-alkanes and mixtures thereof.

The inventive thickener compositions may, as well as the surfactants A and the polymer B, comprise further components.

In a preferred embodiment of the present invention, the thickener composition additionally comprises at least one linear or branched C₆-C₁₈-monoalcohol (C). The monoalcohols have preferably at most one branch. When a plurality of C₆-C₁₈-monoalcohols (C) are present in the inventive thickener composition, they have on average preferably at most 0.5 and more preferably at most 0.2 branch. Preferred C₆-C₁₈ monoalcohols (C) are, for example, n-hexanol, n-heptanol, n-octanol, n-nonanol, n-decanol, n-undecanol and n-dodecanol.

In this preferred embodiment, the inventive thickener compositions comprise advantageously an amount in the range from 0.1 to 20% by weight, preferably from 0.5 to 15% by weight and more preferably from 1 to 8% by weight of C₆-C₁₈-monoalcohols (C) based on the total weight of the components other than water in the inventive composition.

In a specific embodiment, the inventive thickener composition additionally comprises at least one nonionic surfactant (D) of the general formula (IV)

R³—[(O(CH₂)₂)_{z1}(OCH(CH₃)CH₂)_{z2}]—OH (IV)
in which
the sequence of the alkyleneoxy units is as desired,
R³ is selected from C₁₂-C₂₂-alkyl, C₁₂-C₂₂-alkenyl, C₁₂-C₂₂-alkynyl, (C₁₁-C₂₁-alkyl)carbonyl, (C₁₁-C₂₁-alkenyl)carbonyl and (C₁₁-C₂₁-alkynyl)carbonyl
and
z¹ and z² are each independently an integer from 0 to 20, where the sum of z¹ and z² is from 1 to 20.

The R³ radicals of the nonionic surfactants of the general formula (IV) present in the thickener composition preferably have on average at most one, more preferably at most 0.5 and in particular at most 0.2 branch. In particular, the R³ radicals are each independently selected from palmityl, stearyl, oleyl, linoleyl, arachidyl, gadoleyl, behenyl, erucyl, isostearyl, 2-hexyldecyl, 2-heptyldecyl, 2-heptylundecyl and 2-octyldodecyl.

The nonionic surfactants (D) present in the inventive composition have a (poly)alkyleneoxy group which consists of z¹ ethyleneoxy and z² propyleneoxy groups joined to one another in any sequence.

Nonionic surfactants of the general formula (IV) used in accordance with the invention are, for example, provided by reacting natural or synthetic mixtures of fatty alcohols and oxo alcohols with ethylene oxide and/or propylene oxide. This typically affords mixtures of compounds of the formula (IV) with a different number of alkyleneoxy units. These may be used as mixtures in the inventive compositions.

The sum of z¹ and z² averaged over the compounds of the general formula (IV) present is preferably in the range from 1 to 10 and more preferably in the range from 3 to 9. Specifically, each nonionic surfactant of the general formula (IV) present in the thickener composition has, for the sum of z¹ and z², a value in the range from 1 to 10 and more preferably a value in the range from 3 to 9.

The ratio of z¹ to z² averaged over the nonionic surfactants of the general formula (IV) present is preferably at least 2:1. In a specific embodiment of the inventive thickener composition, the (poly)alkyleneoxy groups of the surfactants of the general formula (IV) consist exclusively of ethyleneoxy units. z² is therefore especially 0.

In a further specific embodiment, the inventive thickener composition additionally comprises at least one water-miscible solvent (E) other than the C₆-C₁₈-monoalcohols (C). The solvent (E) preferably has a molecular weight of less than 400 g/mol.

Suitable water-miscible solvents (E) are, for example, homo- and heterooligomers of ethylene oxide and/or propylene oxide, for example ethylene glycol or propylene glycol, alcohols, e.g. methanol, ethanol, isopropanol, butylmonoglycol, butyldiglycol, butyltriglycol, phenoxyethanol, phenoxypropanol or o-sec-butylphenol, N-alkylpyrrolidones such as N-methylpyrrolidone, and alkylene carbonates.

The inventive thickener compositions may optionally, depending on the intended use, comprise further components, for example salts, metal oxide particles, complexing agents, bases, acids, biocides or antifreezes.

Particular preference is given to using the inventive thickener compositions in fluids which are used in the development and/or exploitation of underground mineral oil and/or natural gas deposits. They serve to adjust the rheological properties of these fluids. These fluids are, for example, treatment fluids for breaking-up rock formations, for the acid treatment of rock formations (acidizing), for use during drilling, for workover, for redirecting streams, for controlling permeability and for blocking-off water. They are preferably acid gelling agents or drilling muds.

Depending on the concentration of the components present therein, the inventive thickener compositions enable, using a small amount, the viscosity of the treatment fluids during the treatment to be kept within the viscosity range required over a wide temperature range.

The viscosity range required in the aforementioned treatment fluids is typically between 50 and 100 mPa·s at a shear rate of 100 s⁻¹. The inventive thickener compositions have, at temperatures of 50° C., preferably 60° C. and higher, viscosities above 50 mPa·s.

The present invention further provides a process for treating underground rock formations using an inventive thickener composition, especially in acid gelling agents and/or drilling mud.

In the context of the present invention, the term “acid gelling agent” is used for acidic, relatively highly viscous treatment fluids which are used for acid treatments of underground rock formations.

In the context of the present invention, the term “drilling mud” is used for relatively high-viscosity treatment fluids which are used to flush the borehole during the drilling operation.

The present invention further provides for the use of an inventive thickener composition in washing and cleaning compositions.

As well as the inventive thickener compositions, washing and cleaning compositions comprise at least one liquid or solid carrier, and if appropriate customary additives.

Examples of suitable additives comprise:
builders and cobuilders, for example polyphosphates, zeolites, polycarboxylates, phosphonates, citrates, complexing agents,
ionic surfactants, for example alkylbenzenesulfonates, α-olefinsulfonates and other alcohol sulfates/ether sulfates, sulfosuccinates,
other nonionic surfactants, for example alkylamino alkoxylates and alkylpolyglycosides, amphoteric surfactants, for example alkylamine oxides, betaines,
optical brighteners,
dye transfer inhibitors, for example polyvinylpyrrolidone,
standardizers, for example sodium sulfate, magnesium sulfate,
soil release agents, for example polyethers/polyesters, carboxymethylcellulose,
incrustation inhibitors, for example polyacrylates, copolymers of acrylic acid and maleic acid,
bleach systems consisting of bleaches, for example perborate or percarbonate, plus bleach activators, for example tetraacetylethylenediamine, plus bleach stabilizers,
perfume,
foam inhibitors, for example silicone oils, alcohol propoxylates (in particular in liquid washing compositions),
enzymes, for example amylases, lipases, proteases or carboxylases,
alkali donors, for example pentasodium metasilicate or sodium carbonate.

Further constituents known to those skilled in the art may likewise be present.

Liquid washing compositions may additionally comprise solvents, for example ethanol, isopropanol, 1,2-propylene glycol or butylene glycol.

Gel-form washing compositions additionally comprise thickeners, for example polysaccharides and lightly crosslinked polycarboxylates (for example the Carbopol® brands from BF Goodrich).

In detergents for hard surfaces, for example acidic detergents, neutral detergents, machine dishwashing, metal degreasing, glass detergents, floor detergents, to name just a few, the inventive thickener compositions are used in combination with the additives listed below, which are present in amounts of from 0.01 to 40% by weight, preferably from 0.1 to 20% by weight:
ionic surfactants, for example alkylbenzenesulfonates, α-olefinsulfonates, other alcohol sulfates/ether sulfates, sulfosuccinates
other nonionic surfactants, for example alkylamine alkoxylates and alkylpolyglucosides, including the inventive C₁₃-C₁₅-alkylpolyglucosides
amphoteric surfactants, for example alkylamine oxides, betaines
builders, for example polyphosphonates, polycarboxylates, phosphonates, complexing agents
dispersants, for example naphthalenesulfonic acid condensates, polycarboxylates,
enzymes, for example lipases, amylases, proteases, carboxylases
perfume
dyes
biocides, for example isothiazolinones, 2-bromo-2-nitro-1,3-propanediol
bleach systems consisting of bleaches, for example perborate, percarbonate, plus bleach activators, for example tetraacetylethylenediamine, plus bleach stabilizers
solubilizers, for example cumenesulfonates, toluenesulfonates, short-chain fatty acids, alkyl/aryl phosphates
solvents, for example short-chain alkyl oligoglycols, alcohols such as ethanol or propanol, aromatic solvents such as toluene or xylene, N-alkylpyrrolidones, alkylene carbonates
thickeners, for example polysaccharides and lightly crosslinked polycarboxylates (for example the Carbopol(R) brands from BF Goodrich).

The detergents for hard surfaces are usually, but not exclusively, aqueous and are present in the form of microemulsions, emulsions or solutions.

In addition, the inventive thickener compositions are suitable, for example, for applications in formulations for the treatment of leather and textiles, in hydraulic fluids, in formulations for the treatment of surfaces, in aqueous formulations which are used in structural and civil engineering.

The present invention is illustrated in detail with reference to FIGS. 1 to 7.

FIG. 1 shows the dynamic viscosity of an inventive thickener composition at different concentrations of the components other than water and salt at a temperature of 25° C.

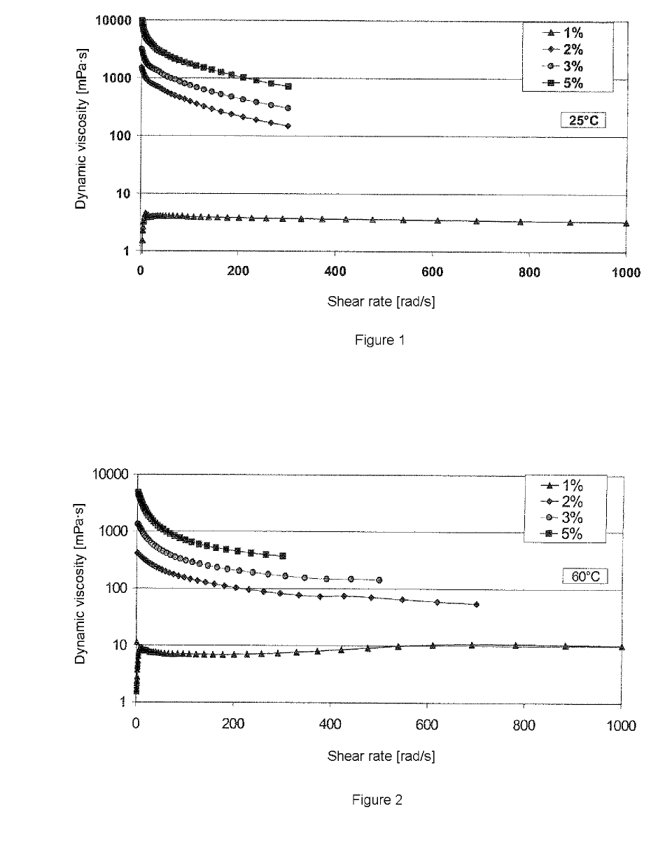

FIG. 2 shows the dynamic viscosity of an inventive thickener composition at different concentrations of the components other than water and salt at a temperature of 60° C.

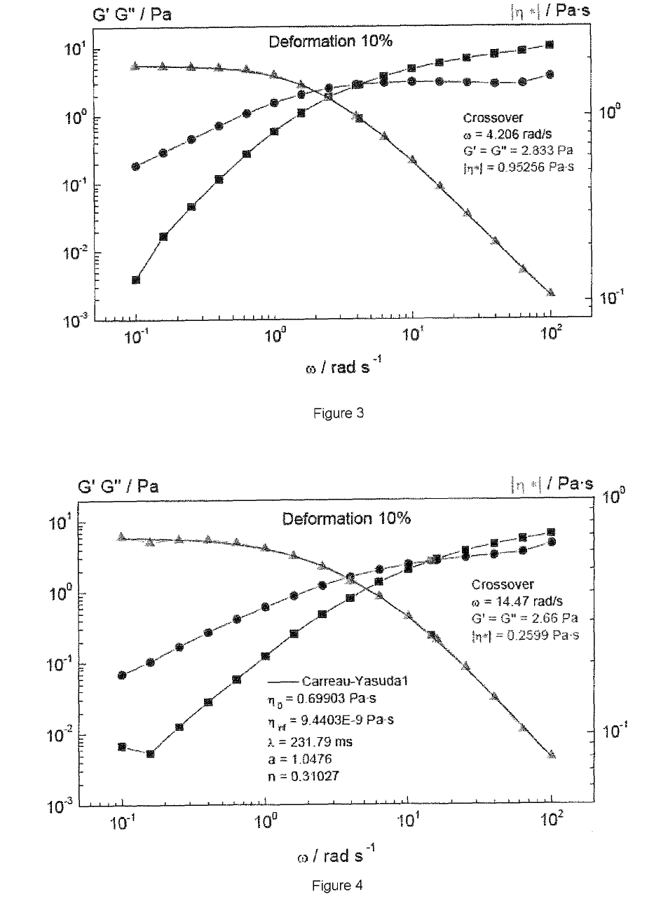

FIG. 3 shows the oscillatory rheology of an inventive thickener composition at a concentration of the components other than water and salt of 2%, at a deformation of 10% and a temperature of 25° C. The values of the elastic component (G′) are shown as ▪. The values of the viscous component (G″) are shown as . The magnitudes of the dynamic viscosity |η*| in Pa·s are shown as ▴.

FIG. 4 shows the oscillatory rheology of an inventive thickener composition at a concentration of the components other than water and salt of 2%, at a deformation of 10% and a temperature of 60° C. The values of the elastic component (G′) are shown as ▪. The values of the viscous component (G″) are shown as . The magnitudes of the dynamic viscosity |η*| in Pa·s are shown as ▴.

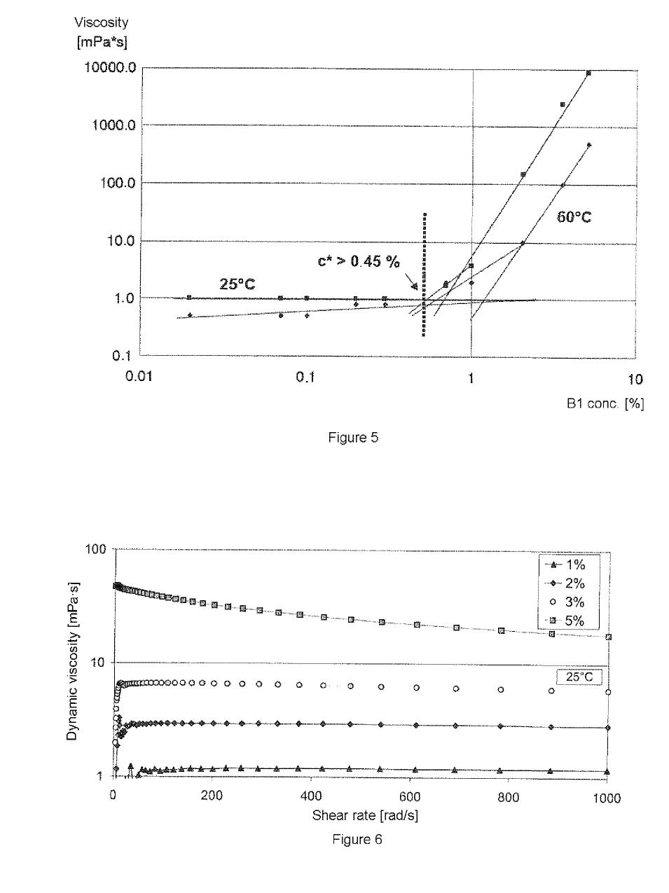

FIG. 5 shows the Theological properties of an aqueous solution of a polymer B used in accordance with the invention at different concentrations and the overlap concentration of the polymer B derivable therefrom.

FIG. 6 shows the rheological properties of an aqueous solution of a surfactant A used in accordance with the invention at different concentrations at a temperature of 25° C.

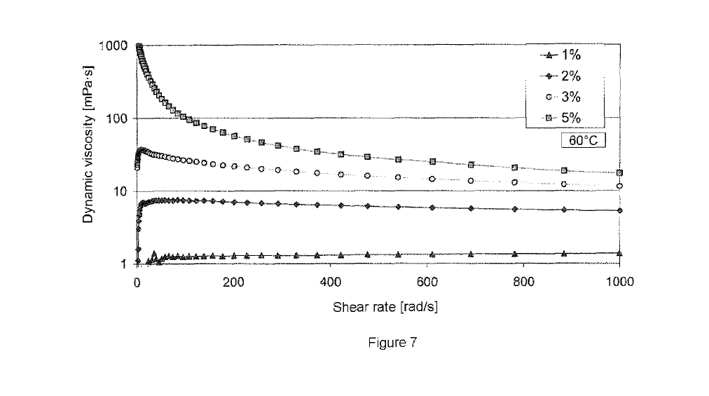

FIG. 7 shows the rheological properties of an aqueous solution of a surfactant A used in accordance with the invention at different concentrations at a temperature of 60° C.

The present invention will be illustrated in detail hereinafter with reference to nonrestrictive examples.

### EXAMPLES

1. Test Methods

The measurements of the shear viscosity at constant, linear shear were performed on a calibrated, thermostated cone-and-plate rheometer of the RheoStress RS 150 type (cone d=60 mm/0.5°).

The oscillatory shear experiments were performed on a calibrated, thermostated cone-and-plate rheometer of the Physika MCR type (cone d=50 mm, 2°). The linear-viscoelastic range of the samples was determined at a temperature of 25° C. up to a shear amplitude of approx. 60% or at a temperature of 60° C. up to a shear amplitude of approx. 20%. Subsequently, the samples were analyzed at a shear of 10% in a frequency-dependent manner, i.e. in a frequency range of from 0.1 to 100 s⁻¹.

2. Preparation Example

a) Surfactant A Used in Accordance with the Invention (A1)

Oleyl alcohol was reacted with about 4.5 equivalents of ethylene oxide in the presence of KOH. This resulted in an ethoxylate having an OH number of 124 mg KOH/g. The resulting ethoxylate was reacted with tetraphosphoric acid in a molar ratio of 3:1. Dilute sodium hydroxide solution was added to the reaction mixture, so as to result in an aqueous solution of oleyl alcohol .4.5 EO . PO₃Na₂, which comprised 25% by weight of oleyl alcohol . 4.5 EO•PO₃H₂.

The critical micelle concentration (cmc) of surfactant A1 in a 3% by weight aqueous KCl solution is 21 mg/l at neutral pH; under the use conditions in the inventive thickener compositions (D1), i.e. at a pH of 4.3, the cmc is 26 mg/l.

b) Polymer B Used in Accordance with the Invention (B1)

25% solution of a reaction mixture comprising the polymers obtained from the reaction of C₁₆-C₁₈-alkyl-[(O—(CH₂)₂)₁₄₀])—OH (78% by weight), of polyethylene glycol (PEG 12 000, 20% by weight) and hexamethylene diisocyanate (2% by weight), in a mixture of 1,2-propanediol, isopropanol and water.

c) Inventive Thickener Compositions (D1)

A mixture consisting of 86% by weight of surfactant A1, 10% by weight of polymer B1 and 4% by weight of n-octanol was homogenized in different concentrations in a 3% by weight aqueous KCl solution and then adjusted with hydrochloric acid to a pH of 4.3.

The thickener composition (D1) in the inventive concentration range is present in clear liquid form within a temperature range from 15 to 90° C.

3. Examination of the Rheological Properties

### Example 3.1

### Examination of the Rheological Properties of an Inventive Thickener Composition (D1)

The rheological properties of four inventive thickener compositions (D1) comprising the components other than water, salt and the organic solvents used to provide component B1 in an amount of 1, 2, 3 and 5% by weight were analyzed on a cone-and-plate rheometer by the test method described above;

a) the results at a temperature of 25° C. are shown graphically in FIG. 1). Depending on the amounts of water, salt and the components other than the organic solvents used to provide component B1, extrapolation gives zero-shear viscosities of the inventive thickener composition of 4 mPa*s for the 1% thickener composition, 1500 mPa*s for the 2% thickener composition, 3200 mPa*s for the 3% thickener composition and of 10 000 mPa*s for the 5% thickener composition, based in each case on the total weight of the thickener composition.

b) the results at a temperature of 60° C. are shown graphically in FIG. 2. At this temperature, extrapolated zero-shear viscosities of the inventive thickener compositions of 7 mPa*s for the 1% thickener composition, 400 mPa*s for the 2% thickener composition, 1300 mPa*s for the 3% thickener composition and 4800 mPa*s for the 5% thickener composition are found, based in each case on the total weight of the thickener composition.

The results of the examination of the rheological properties of the inventive thickener compositions at 25° C. and 60° C. show that, even using an amount of 2% by weight of components other than water, salt and the organic solvents used to provide component B1, based on the total weight of the thickener composition, a significant thickening action is obtained. This thickening action is also maintained at shear rates of a few 100 rad/s.

### Example 3.2

### Examination of the Viscoelastic Properties of an Inventive Thickener Composition (D1) by Oscillatory Rheology

An inventive thickener composition (D1) comprising the components other than water, salt and the organic solvents used to provide component B1 in a concentration of 2% by weight was subjected to the above-described oscillatory shear experiments at a deformation of 10%. From the resulting measurements, the elastic component (G′) and the viscous component (G″) were determined and plotted as a function of frequency. From the point of intersection of the two resulting curves, it is possible in accordance with US 2005/0107503 to determine the gelpoint of the composition.

a) The results of these experiments at a temperature of 25° C. are shown by FIG. 3). The point of intersection of the curves for G′ and G″ obtained for the inventive thickener composition used is at about 4 rad/s. Below this frequency, the thickener composition examined is therefore viscous, i.e. not viscoelastic.

b) The results of these experiments at a temperature of 60° C. are shown in FIG. 4). The point of intersection of the curves for G′ and G″ obtained for the inventive thickener composition used is at about 14 rad/s. Below this frequency, the thickener composition examined is therefore viscous, i.e. not viscoelastic.

### Example 3.3

### Examination of the Rheological Properties of a Polymer B (B1) Used in Accordance with the Invention

Different amounts of component B1 were homogenized in a 3.00% by weight aqueous KCl solution and adjusted to a pH of 4.3 with concentrated hydrochloric acid or KOH. The resulting compositions were analyzed on a cone-and-plate rheometer. The resulting measurements were plotted against a concentration of polymer B1. The graphic evaluation of the measurement series is shown in FIG. 5. The overlap concentration was estimated as described in US 2005/0107503. For the polymer B1 used in accordance with the invention, the resulting curve profile gives rise to an overlap concentration of 0.45% by weight based on the total weight of the aqueous composition.

### Example 3.4

### Examination of the Rheological Properties of an Anionic Surfactant A (A1) Used in Accordance with the Invention

Different amounts (1, 2, 3 and 5% by weight, based on the total weight of the composition) of a mixture consisting of 95.5% by weight of the anionic surfactant A1 and 4.5% by weight of n-octanol were homogenized in an aqueous 3% by weight KCl solution and adjusted to a pH of 4.3 with concentrated hydrochloric acid or with KOH. The resulting compositions were analyzed on a cone-and-plate rheometer.
a) The measurement results at a temperature of 25° C. are shown in FIG. 6). For the surfactant A1 used in accordance with the invention, extrapolation gives rise to a zero-shear viscosity of 1 mPa*s for a 1% composition, 3 mPa*s for a 2% composition, 7 mPa*s for a 3% composition and 50 mPa*s for a 5% composition, based in each case on the total weight of the composition.
b) The measurement results at a temperature of 60° C. are shown in FIG. 7). For the surfactant A1 used in accordance with the invention, extrapolation gives rise to a zero-shear viscosity of 1 mPa*s for a 1% composition, 7 mPa*s for a 2% composition, 40 mPa*s for a 3% composition and 1200 mPa*s for a 5% composition, based in each case on the total weight of the composition.

These measurements show that the anionic surfactant A1, without an inventive polymer B, at an amount used in accordance with the invention, is not capable of building up significant viscosities, i.e. a viscosity of 10 mPa*s is not attained.

1. A thickener system which is suitable for preparing a thickener composition and consists of
(A) at least one anionic surfactant A and
(B) at least one polymer B which comprises at least one hydrophobic group and at least one hydrophilic group,
the concentration of the polymer B in the thickener composition being below the overlap concentration c* of the polymer.

2. The thickener system according to claim 1, in which
(A) at least one anionic surfactant A and
(B) at least one polymer B which comprises at least two hydrophobic radicals R², which are bonded to one another via a bridging hydrophilic group (α),
the concentration of the polymer B in the thickener composition being below the overlap concentration c* of the polymer.

3. The thickener system according to claim 1, in which the concentration of the polymer B in the thickener composition is at least 0.1·c*.

4. The thickener system according to claim 3, in which the concentration of the polymer B in the thickener composition is within a range from 0.3 to 0.7·c*.

5. The thickener system according to claim 1, in which the anionic surfactant A is present in the thickener composition in a concentration at which, without addition of the polymer B, at a shear rate of 100 rad/s, a viscosity of 20 mPa·s is not exceeded.

6. The thickener system according to claim 1, in which the polymer B is present in the thickener composition in a concentration at which, without addition of the anionic surfactant A, at a shear rate of 100 rad/s, a viscosity of 5 mPa·s is not exceeded.

7. (canceled)

8. A process for preparing a thickener composition, comprising
(a) the provision of at least one surfactant A and at least one polymer B, as defined in claim 1,
(b) the preparation of a solution of the anionic surfactant A provided in an aqueous medium,
(c) the preparation of a solution of the polymer B provided in an aqueous medium and
(d) the mixing of the solutions of the surfactant A and of the polymer B prepared, the concentration of the polymer B in the thickener composition prepared being below the overlap concentration c* of the polymer.

9. The process according to claim 8, in which the concentration of the polymer B in the thickener composition prepared is at least 0.1·c*.

10. The process according to claim 9, in which the concentration of the polymer B in the thickener composition prepared is within a range from 0.3 to 0.7·c*.

11. The process according to claim 8, in which the solution of the anionic surfactant A prepared in step b), at a shear rate of 100 rad/s, does not exceed a viscosity of 20 mPa·s.

12. The process according to claim 8, in which the solution of the polymer B prepared in step c), at a shear rate of 100 rad/s, does not exceed a viscosity of 5 mPa·s.

13. The process according to claim 8, in which the solution of the anionic surfactant A prepared in step b), at a shear rate of 100 rad/s, does not exceed a viscosity of 20 mPa·s and the solution of the polymer B prepared in step c), at a shear rate of 100 rad/s, does not exceed a viscosity of 5 mPa·s.

14. A thickener composition comprising a thickener system according to claim 1 in an amount of from 0.1 to 10%.

15. The use of a thickener composition according to claim 13 in the development and/or exploitation of underground mineral oil and/or natural gas deposits.

16. The use of a thickener composition according to claim 13 in washing and cleaning compositions.

17. The use of a thickener composition according to claim 13 in formulations for the treatment of leather and textiles.

18. The use of a thickener composition according to claim 13 in hydraulic fluids.

19. The use of a thickener composition according to claim 13 in aqueous compositions for the treatment of surfaces.

20. The use of a thickener composition according to claim 13 in formulations which are used in structural and civil engineering.

21. A process for treating underground geological formations using a thickener system according to claim 1 in acid gelling agents and drilling mud.
